(19) United States
(12) Patent Application Publication
(10) Pub. No.: US 2024/0337315 A1
(43) Pub. Date: Oct. 10, 2024

(54) ELECTRIC DRIVE ASSEMBLY FOR VEHICLE AND NEW ENERGY VEHICLE

(71) Applicant: Jing-Jin Electric Technologies Co., Ltd., Beijing (CN)

(72) Inventors: Ping YU, Beijing (CN); Yang LIU, Beijing (CN); Fayu PAN, Beijing (CN); Jianwen LI, Beijing (CN); Huaijin LIU, Beijing (CN)

(21) Appl. No.: 18/294,027

(22) PCT Filed: May 16, 2022
(86) PCT No.: PCT/CN2022/093086

§ 371 Date: Jan. 31, 2024

(30) Foreign Application Priority Data
Aug. 3, 2021 (CN) 202121795227.1

(51) Int. Cl. F16H 57/04; B60K 1/00; B60K 17/04; F16H 1/20; F16H 57/02; F16H 57/025

(52) U.S. Cl. CPC F16H 57/0417; B60K 1/00; B60K 17/04; F16H 1/20; F16H 57/025; F16H 57/0409; F16H 57/0423; F16H 2057/02034; F16H 2057/02043

(57) ABSTRACT

A vehicle electric drive assembly and a new energy vehicle are disclosed. The electric drive assembly comprises a motor and a reducer. The motor comprises a motor shaft, and the reducer comprises an input shaft, an intermediate shaft, and an output shaft. The input shaft is fixedly connected to the motor shaft, the output shaft and the input shaft are coaxially provided, the intermediate shaft is provided parallel to the input shaft and the output shaft, and the input shaft drives the output shaft to rotate through the intermediate shaft. The electric drive assembly has the advantages of compact structure, simple manufacturing, low cost, high performance, and small space occupation.

### CROSS REFERENCING OF RELATED APPLICATIONS

This application claims priority from the Chinese patent application No. 202121795227.1 filed with the Chinese Patent Office on Aug. 3, 2021 and entitled “VEHICLE ELECTRIC DRIVE ASSEMBLY AND NEW ENERGY VEHICLE”, the content of which is hereby incorporated by reference in its entirety.

### TECHNICAL FIELD

The present utility model belongs to the field of electric drive assembly technology, and particularly relates to a vehicle electric drive assembly and a new energy vehicle.

### BACKGROUND

At present, among the driving methods of new energy vehicles, one type is a single motor direct driving method, in which a single drive motor directly drives the vehicle's transmission shaft, and there is not a reducer for reducing speed and increasing torque. When it is required that the motor not only meets the high torque power output needs of the entire vehicle, but also meets the economic needs of high-speed driving of the entire vehicle, only low speed and high torque drive motors can be selected. However, this type of drive motor generally has a larger contour and volume and requires higher costs for magnetic steel and coils. Therefore, the single motor direct driving method generally has the problems of large motor volume and high manufacturing cost. Another type of driving method uses a low speed and high torque drive motor and a small speed ratio reducer. Compared with the single motor direct driving method, this driving method reduces the contour and volume of the drive motor to a certain extent, but it also has the problems of large motor volume and high cost; moreover, the function of the reducer for reducing speed and increasing torque is not fully realized.

### SUMMARY

With respect to the above problems, the present disclosure provides a vehicle electric drive assembly and a new energy vehicle in order to overcome or at least partially solve the above problems.

In order to achieve the above object, the present utility model adopts the following technical solutions.

An aspect of the present disclosure provides a vehicle electric drive assembly, wherein the electric drive assembly comprises a motor and a reducer;
the motor comprises a motor shaft, and the reducer comprises an input shaft, an intermediate shaft, and an output shaft;
the input shaft is fixedly connected to the motor shaft, the output shaft and the input shaft are coaxially provided, the intermediate shaft is provided parallel to the input shaft and the output shaft, and the input shaft drives the output shaft to rotate through the intermediate shaft.

Further, the motor shaft and the input shaft are integrally formed.

Further, the input shaft and the output shaft are connected through a bearing.

Further, an output flange is provided on the output shaft.

Further, a first gear is provided on the input shaft, a second gear and a third gear are provided on the intermediate shaft, and a fourth gear is provided on the output shaft; and

the first gear and the second gear are meshed for transmission, and the third gear and the fourth gear are meshed for transmission.

Further, the maximum speed of the motor is not less than 16,000 rpm.

Further, the reducer is provided therein with an oil baffle or an oil retaining rib.

Further, the motor comprises a front housing of motor and a rear housing of motor, and

the reducer comprises a front housing of reducer and a rear housing of reducer; and the front housing of reducer and the rear housing of motor are integrally formed.

Further, a coolant groove is integrated at a bottom of the front or rear housing of reducer, and the coolant groove is used to cool lubricating oil inside the reducer.

Another aspect of the present disclosure provides a new energy vehicle comprising the electric drive assembly as described above.

The advantages and beneficial effects of the present utility model are as follows.

In the vehicle electric drive assembly of the present disclosure, the input shaft of the reducer is fixedly connected to the motor shaft, the output shaft and the input shaft of the reducer are coaxially provided, the intermediate shaft is provided parallel to the input shaft and the output shaft, so that the input shaft drives the output shaft to rotate through the intermediate shaft. The electric drive assembly has the advantages of compact structure, simple manufacturing, low cost, high performance, and small space occupation.

### BRIEF DESCRIPTION OF DRAWINGS

By reading the detailed description of the preferred embodiments below, various other advantages and benefits will become clear to a person of ordinary skill in the art. The accompanying drawings are only used for the purpose of illustrating the preferred embodiments, and should not be considered as a limitation to the present disclosure. Moreover, throughout the drawings, the same reference numerals are used to denote the same components. In the drawings:

FIG. 1 is a schematic diagram of the structure of a vehicle electric drive assembly according to an embodiment of the present utility model.

In the drawings: 1. motor; 2. reducer; 3. motor shaft; 4. input shaft; 5. intermediate shaft; 6. output shaft; 7. bearing; 8. output flange; 9. first gear; 10. second gear; 11. third gear; 12. fourth gear.

### DETAILED DESCRIPTION

In order to make the object, technical solutions, and advantages of the present disclosure clearer, the present disclosure will be described clearly and completely in conjunction with the specific embodiments and corresponding drawings. Obviously, the embodiments described are only part of rather than all of the embodiments of the present disclosure. Based on the embodiments in the present disclosure, all other embodiments obtained by a person of ordinary skill in the art without paying creative work shall fall within the protection scope of the present disclosure.

The technical solutions provided in embodiments of the present utility model will be explained in detail below in conjunction with the accompanying drawings.

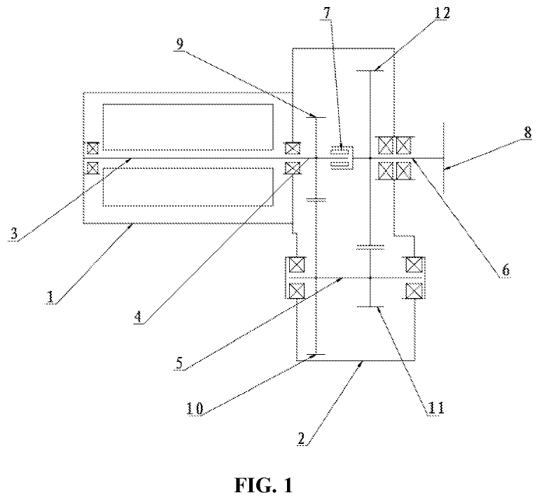

In an embodiment of the present disclosure, a vehicle electric drive assembly is disclosed. As shown in FIG. 1, the electric drive assembly comprises a motor 1 and a reducer 2. The motor 1 comprises a motor shaft 3. The reducer 2 comprises an input shaft 4, an intermediate shaft 5, and an output shaft 6.

Specifically, the input shaft 4 is fixedly connected to the motor shaft 3, the output shaft 6 and the input shaft 4 are coaxially provided, the intermediate shaft 5 is provided parallel to the input shaft 4 and the output shaft 6, and the input shaft 4 drives the output shaft 6 to rotate through the intermediate shaft 5, thereby making the structure of the reducer 2 more compact. The motor 1 outputs power through the reducer 2, thereby achieving the function of speed reducing and torque increasing, and thus improving the output torque of the electric drive assembly and meeting the high torque power output requirements of the vehicle.

The power output path of the electric drive assembly is as follows: the power of the motor 1 is transferred through the motor shaft 3 to the input shaft 4; the input shaft 4 drives the intermediate shaft 5 to rotate and then drives the output shaft 6 to rotate; finally, the power is output through the output shaft 6.

In sum, in the vehicle electric drive assembly of this embodiment, the input shaft of the reducer is fixedly connected to the motor shaft, the output shaft and the input shaft of the reducer are coaxially provided, and the intermediate shaft is provided parallel to the input shaft and the output shaft, so that the input shaft drives the output shaft to rotate through the intermediate shaft. The electric drive assembly has the advantages of compact structure, simple manufacturing, low cost, high performance, and small space occupation.

In an embodiment, as shown in FIG. 1, the motor shaft 3 and the input shaft 4 are integrally formed. The integrated design not only makes the transmission structure of the electric drive assembly more compact to meet the high centering and high dynamic balance requirements for motor shaft 3 when rotating at a high speed, but also reduces power loss during power transmission and improves transmission efficiency. To a certain extent, it also improves the NVH (noise, vibration, harshness) performance of the electric drive assembly and reduces the manufacturing cost of the electric drive assembly.

In an embodiment, as shown in FIG. 1, the input shaft 4 and the output shaft 6 are connected through a bearing 7, which can achieve relative fixation of the input shaft 4 and the output shaft 6, and prevent instability of the input shaft 4 and the output shaft 6 during rotation. Moreover, any additional fixing structure is not needed to fix the input shaft 4 and the output shaft 6, so that the structure of the electric drive assembly is simpler.

Furthermore, an output flange 8 is provided on the output shaft 6 for fixed connection with the transmission shaft on the vehicle, so that the output shaft 6 transmits power to the transmission shaft on the vehicle through the output flange 8. Of course, alternatively, a coupling may be installed on the output shaft 6, and the output shaft 6 is connected to the transmission shaft on the vehicle through the coupling, which is also within the protection scope of the present disclosure.

In one or some embodiments, as shown in FIG. 1, a first gear 9 is provided on the input shaft 4, a second gear 10 and a third gear 11 are provided on the intermediate shaft 5, and a fourth gear 12 is provided on the output shaft 6.

The first gear 9 and the second gear 10 are meshed for transmission; the third gear 11 and the fourth gear 12 are meshed for transmission. By adjusting the transmission ratio between gears based on the performance of the vehicle and the motor, it is possible to achieve high transmission speed ratio of the reducer, and further improve the output torque of the electric drive assembly.

In an embodiment, the maximum speed of the motor is not less than 16,000 rpm, and the specific model of the motor can be determined based on the type of vehicle used, the power performance and economic requirements of the motor, as well as the transmission speed ratio of the reducer. For example, when the type of vehicle is a low-speed, high-power off-road vehicle, the maximum motor speed of 16,000 rpm can meet the demand.

In this embodiment, the motor is a high speed and low torque drive motor, and has the advantages of small size, light weight, low cost, and high power density. When cooperated with the large transmission speed ratio reducer mentioned above, compared with the conventional electric drive assembly with the same maximum power and maximum torque, the volume of the electric drive assembly in this embodiment is smaller by about 20%, especially the electric drive assembly is reduced by about 10% to 15% in height and width, and the weight is reduced by about 5% to 10%, which facilitates the spatial arrangement of the electric drive assembly within the vehicle.

In one or some embodiments, the reducer is provided therein with an oil baffle or an oil retaining rib, which can reduce the amount of lubricating oil splashed by the reducer gear during rotation, thereby reducing the power loss caused by the reducer gear stirring oil.

In an embodiment, the motor comprises a front housing of motor and a rear housing of motor; the reducer comprises a front housing of reducer and a rear housing of reducer.

In order to improve the integration of the reducer, reduce the axial length and mass of the reducer, and reduce the manufacturing cost of the electric drive assembly, the front housing of reducer and the rear housing of motor are integrally formed.

In an embodiment, in order to improve the heat dissipation performance of the reducer and thereby enhance the overall performance of the electric drive assembly, a coolant groove is integrated at the bottom of the front or rear housing of reducer. The coolant groove is used to cool the lubricating oil inside the reducer. The coolant flows through the coolant groove and can quickly remove the heat inside the reducer.

In an embodiment of the present disclosure, a new energy vehicle is disclosed. The new energy vehicle comprises an electric drive assembly described in any of the above embodiments, and has the advantages of low cost, excellent NVH performance, high efficiency, and high reliability.

The above merely describes particular embodiments of the present disclosure. By the teaching of the present disclosure, a person skilled in the art can make other modifications or variations based on the above embodiments. A person skilled in the art should appreciate that, the detailed description above is only for the purpose of better explaining the present disclosure, and the protection scope of the present disclosure should be subject to the protection scope of the claims.

1. A vehicle electric drive assembly comprising:
a motor having a motor shaft; and
a reducer having an input shaft, an intermediate shaft, and an output shaft,
wherein the input shaft is fixedly connected to the motor shaft, the output shaft and the input shaft are disposed coaxially to each other, the intermediate shaft is disposed parallel to the input shaft and the output shaft, and the input shaft is configured to drive the output shaft to rotate through the intermediate shaft.

2. The electric drive assembly according to claim 1, wherein the motor shaft and the input shaft are integrally formed.

3. The electric drive assembly according to claim 1, wherein the input shaft and the output shaft are connected through a bearing.

4. The electric drive assembly according to claim 1, further comprising an output flange on the output shaft.

5. The electric drive assembly according to claim 1, further comprising:
a first gear on the input shaft;
a second gear and a third gear on the intermediate shaft; and
a fourth gear on the output shaft;
wherein the first gear and the second gear are meshed for transmission, and the third gear and the fourth gear are meshed for transmission.

6. An electric drive assembly according to claim 1, wherein a maximum speed of the motor is not less than 16,000 rpm.

7. An electric drive assembly according to claim 1, wherein the reducer comprises therein at least one of an oil baffle and an oil retaining rib.

8. The electric drive assembly according to claim 1,
wherein the motor comprises a front housing of motor and a rear housing of motor,
wherein the reducer comprises a front housing of reducer and a rear housing of reducer; and
wherein the front housing of reducer and the rear housing of motor are integrally formed.

9. The electric drive assembly according to claim 8, further comprising a coolant groove integrated at a bottom of the front or rear housing of reducer, the coolant groove configured to cool lubricating oil inside the reducer.

10. A new energy vehicle comprising the electric drive assembly according to claim 1.

11. An electric drive assembly according to claim 2, wherein a maximum speed of the motor is not less than 16,000 rpm.

12. An electric drive assembly according to claim 3, wherein a maximum speed of the motor is not less than 16,000 rpm.

13. An electric drive assembly according to claim 4, wherein a maximum speed of the motor is not less than 16,000 rpm.

14. An electric drive assembly according to claim 5, wherein a maximum speed of the motor is not less than 16,000 rpm.

15. An electric drive assembly according to claim 2, wherein the reducer comprises therein at least one of an oil baffle and an oil retaining rib.

16. An electric drive assembly according to claim 3, wherein the reducer comprises therein at least one of an oil baffle and an oil retaining rib.

17. An electric drive assembly according to claim 4, wherein the reducer comprises therein at least one of an oil baffle and an oil retaining rib.

18. An electric drive assembly according to claim 5, wherein the reducer comprises therein at least one of an oil baffle and an oil retaining rib.

19. A new energy vehicle comprising the electric drive assembly according to claim 5.

20. A new energy vehicle comprising the electric drive assembly according to claim 8.
